(19) United States
(12) Patent Application Publication
(10) Pub. No.: US 2007/0199228 A1
(43) Pub. Date: Aug. 30, 2007

(54) Decoy exhibiting realistic spectral reflectance

(76) Inventor: Aaron Henry Johnson, Frontier, ND (US)

Correspondence Address: JONATHAN LOUIS TOLSTEDT, 1005 19TH STREET SOUTH, FARGO, ND, 58103, US

(21) Appl. No.: 11/711,409

(22) Filed: Feb. 27, 2007

Related U.S. Application Data
(60) Provisional application No. 60/777,256, filed on Feb. 27, 2006.

(51) Int. Cl. A01M 31/06

(52) U.S. Cl. 43/3

(57) ABSTRACT

A decoy with a surface reflection which closely matches the spectral reflectance of the animal or object that it is designed to mimic, including both human-visible and ultraviolet wavelengths, with the intent of making the decoy appear more realistic to animals who can see in both the human-visible and ultraviolet spectrums.

### CROSS-REFERENCE TO RELATED PATENT APPLICATIONS

This patent application claims priority to U.S. Provisional Patent Application No. 60/777,256, entitled, “Spectrally matched devices and coatings,” and filed on Feb. 27, 2006. The entire disclosure of the above-noted patent application is incorporated by reference in its entirety herein.

### FIELD OF INVENTION

This invention relates to decoys and other replicates of animals, as used for hunting, for attraction of animals, or for other purposes. In particular, this invention involves a decoy having a surface reflectance that is matched to the light reflection of the animal is it intended to mimic, including ultraviolet wavelengths.

### BACKGROUND OF THE INVENTION

Decoys are commonly used for the hunting of animals such as waterfowl, turkey, dove, deer, and antelope. Decoys exist in numerous forms, including full body decoys and two-dimensional “silhouette” decoys, among others. Regardless of its form, the purpose of a decoy is to mimic a particular species in order to attract animals or for the purpose of deceiving animals to elicit a desired behavior.

In the production of decoys, much attention is given to making a decoy look as much like the intended animal as possible. The color of a decoy is matched to the color of the animal using techniques common within the industry. Glare from decoys is reduced using various surface treatment methods. Many products are designed so that motion is induced in the decoy. All of these techniques are employed in order to increase the “realism” of the decoy, as it is well understood that increased realism in decoys corresponds to higher performance (i.e., a decoy that better attracts the intended animal).

It remains a common misconception even today that most animals are color blind. For years it was believed that animals had vision systems that were more primitive than human's three primary color (trichromatic) vision. Modern research is showing that non-human primates are trichromatic and most non-mammal animals, including fish, birds, and shrimp, have vision systems and color perception far beyond humans and primates. It has also been confirmed that many non-primate mammals, while being limited to two primary colors (dichromatic) often are more perceptive of blue colors than humans and even see into ultraviolet (UV) wavelengths. Birds and fish, for instance, are most commonly tetrachromatic; that is, they perceive colors based on a blend of four primary colors. Some animal species even possess five primary colors. These primary colors are determined by the animal's cones, which are special cells in the retina of the eye. Humans possess three types of cones, each having peak sensitivity at specific wavelengths: one at the wavelengths corresponding to blue light, one at the wavelengths corresponding to green light, and one at the wavelengths corresponding to red light—hence our blue, green, and red primary colors. All other colors perceived by humans are the result of these cones being stimulated simultaneously (e.g., simultaneous stimulation of red and green cones causes a human to perceive “yellow”). Birds and fish generally possess four types of cones, although this can vary from one species to another and also through genetic mutations. Other mammals, such as deer, possess only two types of cones, but one of these cones is sensitive to ultraviolet wavelengths.

This combination of having more cone-types than humans and having the ability to see UV light means that the color perception of many animals is more precise and discriminating than human color perception. That is, animals are capable of seeing color differences that are not apparent to humans.

Critical to creating realism in decoys is the understanding of vision and color perception in animals. Recent development in the science of color perception in animals has ramifications for decoy manufacturers. The discovery that birds and other game animals can perceive UV light has led some manufacturers in the hunting industry to develop products and modify existing products in an attempt to exploit this discovery. Most manufacturers of hunting products, however, remain unaware of recent scientific developments or are unaware how these developments can be utilized.

Those manufacturers that have attempted to adapt their products to recent discoveries in animal color perception have not understood the science correctly and have not made the conceptual leap necessary to understand the fundamental differences in color perception between species. The best example, and the most applicable to the present invention, is the development of UV absorbing sprays for use on camouflage and decoys, and the marketing of so-called UV absorbing paints, inks and coatings on decoys. Inventors and manufactures of these products have learned that birds and other game animals can see UV light and have concluded, incorrectly, that UV light is “man-made” and “bad” and must be eliminated from hunting products lest the game animals see the decoys or camouflage for what they are. UV light has been described as having an “eerie glow” that frightens game animals away or a kind of invisible “glare” that must be covered up.

US patent application 20060117637 by Jeckle describes a coating that absorbs UV light designed to be used for waterfowl decoys, camouflage, and hunting blinds. Also, a product called U-V-Killer™ from Atsko, Inc. is marketed to hunters for the purposes of eliminating all ultraviolet light reflection and blue fluorescence from camouflage clothing and other hunting products.

While products like these recognize that many animals can see ultraviolet light, they fail to account for the fact that animals themselves as well as other natural objects often reflect UV light. Rather, they teach the opposite, that UV light reflection is unnatural and should be avoided to improve hunting success. Some of these products are intended to be sprayed onto painted decoys, for instance, to make the surface of the painted decoy UV absorbing. Yet it is well known by those skilled in the art of paint formulation that virtually all paint, with the exception of some deep colors, uses UV absorbing titanium dioxide as the primary lightening/whitening pigment and as such, is already inherently UV absorbing. Many exterior durable materials also contain UV absorbing light stabilizers to protect the material from UV degradation. These products teach the application of UV absorbing coatings onto surfaces that often are already UV absorbing.

Some fishing lures have been developed to reflect or emit UV light to be more visible to the fish, especially at deeper depths. These fishing lures, however, do not teach whether UV should be absorbed or reflected, or whether it is “good” or “bad” on hunting products. It is well know that fishing lures can be rendered more effective by making them more visible, more colorful, and even shinier—depending on the fishing circumstances. It is well know that fishing lures can be effective even when they do not resemble any known bait fish. UV reflecting fishing lures do not teach what will make decoys and camouflage more effective. This art does not teach the natural UV reflection level and pattern of bait fish, only that generic UV reflection can make lures more visible to fish. This art also does not teach how to determine the natural UV reflection of bait fish, other game animals, or natural objects.

While many man-made objects, especially conventional paints, absorb UV light, recent research has shown that many natural objects as well as animals can reflect UV light. This reflection, while not visible to humans, can be seen through the use of ultraviolet photography, in which UV light is converted to colors that can be perceived by humans. UV photography has revealed patterns and coloration in animals, plants, and other natural objects that may be used by animals or insects for the purposes of identification or attraction.

A study by Eaton and Lanyon (“The ubiquity of avian ultraviolet plumage reflectance” published in the Proceedings of the Royal Society of London—Biological Sciences in 2003), measured the UV reflection of hundreds of bird feather patches of different colors using UV-Visible spectrophotometry. This study showed that some colors such as white typically exhibited some level of UV reflection but the amount of reflection varied significantly between species. This study, the most comprehensive attempt to date to classify the UV reflectance of birds, did not include the grays, tans, and other light earth tones typically found in many game birds, nor did it investigate the overall pattern of UV reflection for any bird. Other studies have shown that some species of birds have black feathers with significant UV reflection while other black feathers have virtually no UV reflection.

Taken in their entirety, the present knowledge of UV reflectance in bird plumage cannot be used successfully to predict the amount of UV reflection of a bird based on the human-visible color of the feathers. Feathers that appear white to humans can possess UV reflection from low to moderate to high depending on the species of bird and the location of the feather on the bird. Often male/female pairs of bird species that appear to be identical to humans actually have differing UV reflectance characteristics, making the color difference between the sexes very obvious to birds.

While is has been established that many game animals can see UV light—although many manufacturers are unaware of it, and those that are aware of it have taught away from the present invention—and it has been established that many animals and natural objects possess UV reflection, it has not been taught by any art, nor is it obvious, what the specific UV reflection of any or all surfaces (such as plumage and fur) of game animals is and how this knowledge, were it to be obtained, can be properly exploited to improve the performance of hunting products such as decoys.

Jeckle acknowledges this lack of knowledge within the art, stating in 20060117637 that “It is impractical, if not impossible to precisely duplicate the natural reflectance of UV light off the feathers of birds because the reflectance and color hues are in the UV range that humans cannot perceive. Without being able to perceive the reflectance, any attempt of realistically mimicking the reflection is guesswork.” Jeckle concludes that “The solution to this problem is to diminish the reflectance of ultraviolet light while maintaining a presumptively natural appearance in the visible spectrum.”

It is clear that the UV reflectance levels and patterning of game animals and natural objects such as foliage and a means to reproduce that reflectance on decoys and other hunting products is not known. Jeckel and others teach that because of this lack of knowledge, the only option is to eliminate UV reflection.

Various materials are used to make decoys, including molded plastics, extruded plastics, polymer foams, and woven or non-woven fabrics. To provide human-visible color for the intended species, several methods can be used. One is to use the inherent color of the material, as is sometimes the case with fabrics and foams. Another method is to incorporate color pigments directly into the material using color compounding methods common in the plastics industry. The most common method is to apply a surface coating, typically an ink or paint that is formulated to have the desired human-visible color. Often, a combination of these methods is used.

A search of the prior art will show patents and other documents that discuss the use of materials that are sensitive to or resistant to UV light, but these prior art references do not teach the measurement and use of the reflection of UV light. Some references refer to “UV resistance”, which involves the use of materials and coatings to prevent damage such as yellowing due to the effects of UV light. UV-resistant materials are typically UV absorbing, or transparent (in the case of some clear materials), and therefore can not be used to mimic the UV reflectance patterns of animals or objects. Other references discuss the use of UV inks on their products. UV inks are special inks that can be cured under the presence of high-intensity UV light, but they are not intended to reflect UV light.

Regardless of how artificial color is incorporated, it is formulated to match the intended species or natural object based on human color perception, without accounting for the differences between human and animal color vision. Industrially, color matching is typically done using the L-a-b scale, which assigns each color a point in the three dimensional space defined by three axes: L (lightness), a (magenta to green) and b (blue to yellow). This system is based on the peak sensitivity of the cones of the human eye and is therefore an inadequate method for matching colors as perceived by animals.

Ultraviolet-visible (UV-Vis) reflectance spectrophotometry is an analytical method of measuring the reflection of light from a surface over a range of wavelengths. Instruments used for this measurement shine light at an object and measure the intensity of the reflected light. By changing the wavelength of the incident light, a graph of the intensity of reflected light versus wavelength can be developed. Using this method to assist the matching of colors is not dependant on the color vision of humans and therefore avoids the inadequacies of the L-a-b method for animal color vision.

While many “man-made” objects are UV-absorbing, some materials, including some fabrics and polymer foams which are naturally white in color, reflect UV light. However, this UV reflection does not match that of any specific animal species and may be either more or less reflective at a particular wavelength. Other materials that appear white to humans are UV fluorescent, which means they absorb UV wavelengths and emit light at human-visible longer wavelengths. This is why some fabrics appear extra-bright under a UV emitting black light. This effect alters the color of the object in a way that can be perceived by some animals.

U.S. Pat. No. 4,691,464 by Rudolph describes a flexible fabric covering which can be placed over a decoy in an attempt to enhance the life-like accuracy of the decoy. Rudolph describes the use of reflective panels placed in strategic locations on the fabric covering in an attempt to match the iridescence of the brightly colored secondary feathers of a bird. Iridescence is created by manipulating the surface material such that the color of the surface appears to shift depending on the angle by which the surface is observed. Iridescence does not affect the UV characteristics of the decoy, and the use of a reflective panel on a decoy covering does not accurately mimic the reflective characteristics of a decoy as seen by an animal. Rudolph does not teach the use of UV reflective characteristics to mimic those of an animal.

The UV reflection properties of minerals have been measured and it is known, though not widely, by those skilled in the art, which pigments and fillers may be used to achieve ultraviolet light reflection. Snow is known to have high UV reflection and materials such as Tyvek have been found to have similar UV reflection to snow and have been cited as a material of choice for snow camouflage for military applications. Snow and Tyvek have relatively flat reflectance curves when measured across the UV spectrum of sunlight. Bird feathers have complex reflection curves, or signatures, where each wavelength of UV light (and visible wavelengths) has a different reflectance level. This complexity of reflection curvatures in the UV of animal feathers, fur, and plant foliage is not fully understood, with only a fraction of natural, plant, or animal surfaces having been studied for UV reflection.

It is also not known which pigments, materials, or combinations of materials are needed to produce the UV reflection signature of game animals. UV reflection is not a singular thing any more than blue or red are singular colors. There are an infinite number of possible reflectance curvatures across the UV wavelengths visible to animals, just as there are an infinite number of possible reflectance curvatures in the human-visible range that we perceive as innumerable shades of blues, red, yellows, etc.

To achieve maximized color realism, and therefore improved performance, what is needed is a decoy that is designed to match or closely mimic the coloration and patterning in the entire light reflectance spectrum of the vision system of the animal which it is intended to mimic. To develop decoys that match the UV reflection of the animal, plant, or natural surface the product is mimicking requires filling the knowledge gap of the UV reflection signatures of those surfaces. To determine those UV signatures requires refining a method to determine said signatures. When the UV signatures are known, the next step needed is to synthesize existing art in materials sciences (for example, paint color matching in the visible wavelengths) with what is known about the UV reflection of materials. This effort must be combined with the study of the UV reflection of candidate materials whose UV reflection is not known. This gained knowledge and newly developed methods must then be successfully applied to decoy manufacturing methods.

### SUMMARY OF INVENTION

In one aspect of the invention, the outer surface of an animal decoy is modified to match or closely mimic the actual reflectance of the animal in the wavelengths of light which are visible to the animal.

In another aspect of the invention, portions of the outer surface of an animal decoy are modified to possess bright UV reflectance where white areas exist on the corresponding areas of the animal, and moderate UV reflectance where gray or tan areas exist on the corresponding areas of the animal.

These aspects and others are achieved by the present invention, which is described in detail in the following specification and accompanying drawings which form a part hereof.

### BRIEF DESCRIPTION OF DRAWINGS

FIG. 1 shows the typical ultraviolet reflectivity patterns of two types of waterfowl.

FIG. 2 shows the ultraviolet reflectance curves given by the various body parts of typical waterfowl compared against the ultraviolet reflectance curves given by typical decoy coatings and materials found in the prior art.

FIG. 3 illustrates an ultraviolet imaging system used to determine the patterns and relative intensity of the UV reflecting area of an animal.

FIG. 4 illustrates a laboratory set up using a UV-Vis spectrophotometer to determine the quantitative reflectance curve across the spectrum of the animal vision system.

FIG. 5 is a flowchart of the process of creating animal decoys exhibiting realistic UV reflections.

### DETAILED DESCRIPTION

It must be understood that, just as the human-visible colors present on an animal vary greatly over the surface of that animal, the ultraviolet (UV) light reflected from the surface of that animal also varies greatly. A human-visible color such as the green found on the head of a drake Mallard duck is simply a set of reflected wavelengths of light that falls within the spectrum of light visible to humans; specifically, it is wavelengths of light that humans perceive as the color green. Depending on the exact wavelength and intensity of the reflected light, the color “green” may range in appearance from blue-green to yellow-green. Similarly, the amount of UV light, as well as the specific wavelengths of UV light, reflected from the surface of an animal can vary greatly, creating different “colors” of UV light. Although these UV colors are not visible to humans, they are visible to many animals, and should be accounted for when creating realistic models or decoys of those animals. That is the intent of the present invention.

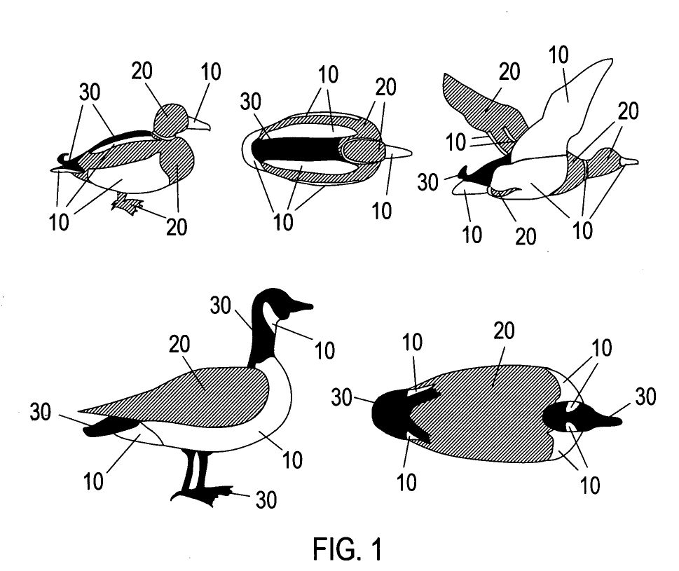

FIG. 1 illustrates the UV reflectance patterns of two different waterfowl. Although waterfowl are used as examples herein, it should be understood that any type of animal can be used with similar results. FIG. 1 shows areas of high UV reflectance 10, areas of medium UV reflectance 20, and areas of little or no UV reflectance 30 in the patterns in which they would typically appear on a drake Mallard duck or a Canada goose. Although the present invention shows areas of high UV reflectance 10 are often seen associated with areas of white or light human-visible colors on the waterfowl, studies have shown that this is often not the case for all white colored animals. Similar studies have shown that areas of black can be associated with significant UV reflectance, and areas of white can have very little UV reflectance.

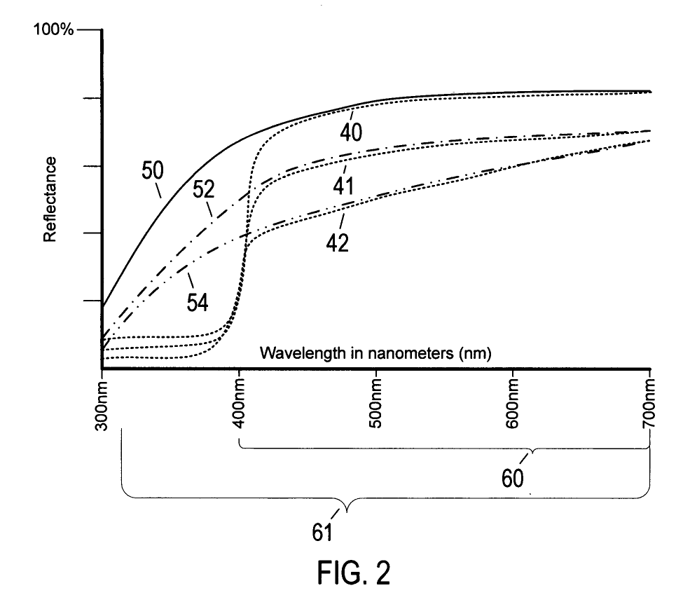

FIG. 2 illustrates the UV-Visible reflectance curves of example game animals as compared to materials found in the prior art used for coating decoys. The visual spectrum of humans 60 and the visual spectrum typical of birds and fish 61 are indicated along the bottom access of the line graph. The reflectance curves of several materials taught in the prior art, including white 40, light tan 41, and tan 42, are shown. Each of the materials 40, 41, and 42 demonstrates very little reflectance in the wavelengths of ultraviolet light between 300 and 400 nanometers. The reflectance curves of a Snow goose body and wing 50, a Canada goose cheek patch 52, and a Canada goose breast 54 are also shown. The reflective characteristics of animal components 50, 52, and 54 cannot adequately be implemented using materials 40, 41, and 42. Animals which can see in the visual spectrum of birds and fish 61 will see materials 40, 41, and 42 as significantly different colors than animal components 50, 52, and 54, even though materials 40, 41, and 42 will appear as close matches in the human visible spectrum 60.

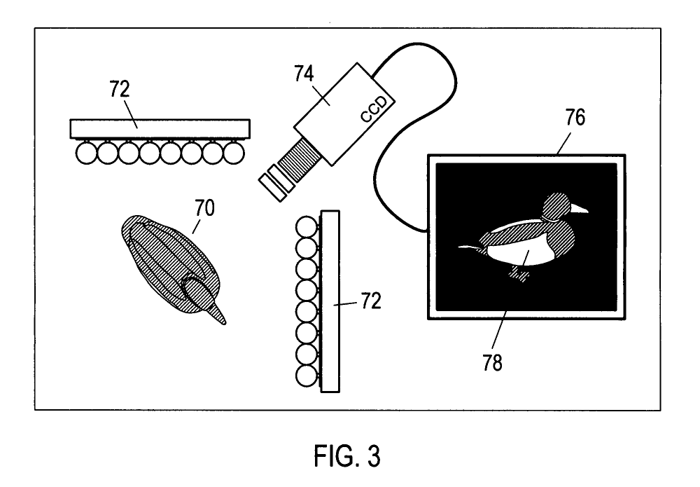

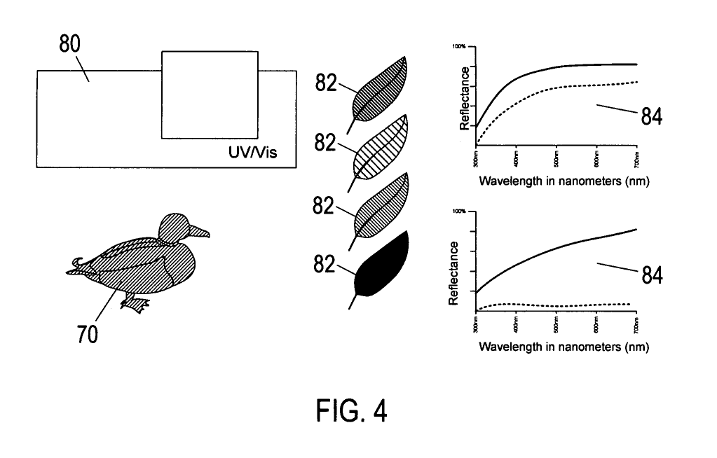

The present invention describes a method of mapping the reflectance characteristics of the outer surface of an animal. Refer now to FIG. 3 and FIG. 4. FIG. 3 illustrates a test set-up which uses UV imaging or similar techniques to determine areas of low, medium, and high reflectance on the outer surface of the animal. The animal subject 70 is placed in front of a UV imaging camera 74. Light sources 72 emit ultraviolet light onto the animal subject 70, and the reflected UV light is detected by the UV imaging camera 74. A monochrome image 78, showing areas of high UV reflectance as bright areas, moderate UV reflectance as shades of gray and no UV reflectance as dark areas, is displayed on a computer display 76. The data from the image 78 is interpreted and recorded to show a map like that shown in FIG. 1.

FIG. 4 illustrates an additional step in which the animal subject 70 is mapped with a UV-Vis spectrophotometer 80 to determine the quantitative reflectance curves 84 across the spectrum of the animal vision system. Surface measurements are taken from whole or partial samples 82 from carcasses or other natural samples. A reflectance curve 84 is generated in this manner for each different sample 82. Example reflectance curves 84 can be seen in greater detail for the animal components 50, 52, and 54 on FIG. 2.

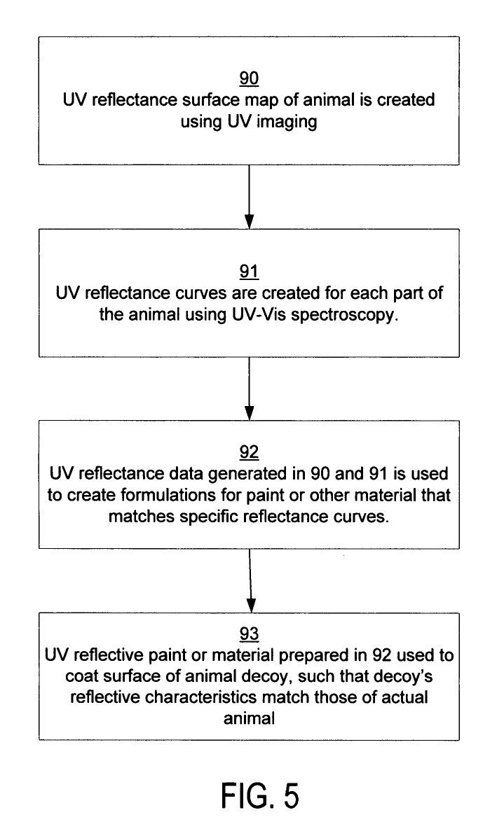

FIG. 5 is a flowchart of the process of creating animal decoys exhibiting realistic UV reflections. In Step 90, a UV reflectance surface map is created for the animal subject 70. This is done by the UV imaging process previously described herein in FIG. 3. In Step 91, UV reflectance curves 84 are created for various samples 82 of an animal carcass. This is done by the UV-Vis process previously described herein in FIG. 4. The UV image 78 and reflectance curves 84 are analyzed to create specific formulations of paint or other surface covering material, as shown in Step 92. In Step 93, the UV-reflective paint or material is applied to the outer surface of an animal decoy, or the decoy itself is composed of said materials, to create a model of the animal subject 70 that appears visually realistic to the animal in the animal's visual spectrum.

The methods of modifying the outer surface of an object to change its reflective characteristics, as described in Step 93 on FIG. 5, are known to someone skilled in the art, but a short description of these methods is provided herein. Two methods exist for changing the color or light-reflecting characteristics of an object, adding pigments to the surface of the object, or changing the structure of the surface such that the light reflected from that surface changes. Specifically, these techniques can be used to add varying levels of UV reflectance to an object.

The pigments used to achieve UV reflectance can be several organic and inorganic pigments that posses UV reflectance. Specifically, barium sulfate, calcium carbonate, antimony oxide, magnesium oxide, strontium carbonate, barium carbonate, many zirconates and zirconias, many metals and metal oxides, some ceramic powders, and many titanates, among others, are known to reflect UV light.

The coatings or plastic resins used to carry the UV reflecting pigments can be several types but the preferred materials are UV transparent or otherwise resistant to UV degradation. Specifically, binders utilizing acrylic are preferred. Organic or inorganic binders used in coatings can also be used that are partially or selectively UV or visible light absorbing.

Another method of creating UV reflection is altering the structure of the surface such that the amount and type of light reflected is changed. Specifically, creating small voids within or microstructures on the surface or coating can scatter UV light because of the refractive index difference between the material and the voids. This can be accomplished by adding fillers at high concentrations, above what is known as the critical pigment volume concentration, by adding particles which themselves have small voids, or by using processes that create voids. This void scattering is also accomplished with certain materials such as some fabrics like Tyvek and some foam plastics.

Having described the preferred embodiment, it will become apparent that various modifications can be made without departing from the scope of the invention as defined in the accompanying claims. In particular, any animal, plant, seeds, or even an object, can be used as a decoy if it aids in the deception of an animal or human. The animals discussed directly herein are intended as examples only. In addition, methods of measuring the UV reflectance of an animal other than those discussed herein may be used to achieve the same or similar results.

What is claimed:

1. A decoy with a surface reflection that closely matches the spectral reflectance of the animal or object that it is designed to mimic.

2. The decoy of claim 1, wherein the spectral reflectance includes wavelengths within the human visible spectrum as well as ultraviolet wavelengths.

3. The decoy of claim 1, wherein only certain areas of the decoy have a surface reflection which closely matches the spectral reflectance of the animal or object that it is designed to mimic.

4. A decoy that has been designed to maximize the ultraviolet light reflection from a portion of the outer surface area of the decoy for the purpose of making the decoy more easily seen by animals.

5. The decoy of claim 4, wherein the portion of the outer surface area comprises the entire outer surface area of the decoy.

6. The decoy of claim 4, wherein the portion of the outer surface area comprises only those areas of the decoy which reflect a predetermined amount of ultraviolet light.

7. A surface material for a decoy that has been formulated to closely match the spectral reflectance of the animal or object for which the decoy is designed to mimic.

8. The surface material of claim 7 wherein the surface preparation material is a coating, ink, plastic, fabric or paint.
